(19) United States
(12) Patent Application Publication
(10) Pub. No.: US 2010/0108622 A1
(43) Pub. Date: May 6, 2010

(54) LOCKING ASSEMBLY

(76) Inventors: George S. Gabriel, Seaford, DE (US); Rodney Gerringer, Forest Hill, MD (US); Dale Murray, Elkton, MD (US); Edward K. Eldreth, Port Deposit, MD (US); Chinsoo Park, Salisbury, MD (US); Lynn Irwin, Seaford, DE (US); Arlene Murray, Elkton, MD (US)

Correspondence Address: STROOCK & STROOCK & LAVAN LLP, 180 MAIDEN LANE, NEW YORK, NY, 10038, US

(21) Appl. No.: 12/613,433

(22) Filed: Nov. 5, 2009

Related U.S. Application Data
(60) Provisional application No. 61/112,045, filed on Nov. 6, 2008.

(51) Int. Cl. A47B 96/00; E05B 73/00

(52) U.S. Cl. 211/4; 211/85.17

(57) ABSTRACT

A locking assembly for securing and retaining a cage to a rack. The locking assembly is supported by a rack and includes a lock member. The lock member includes an obstruction member. The lock member is movable from an unlocked position to a locked position, wherein the default position of the lock member is the locked position. The lock member is designed and constructed such that the insertion of a person's hand into the hand space between the lock member and a cage is sufficient to cause the lock member to pivot into the unlocked position and move the obstruction member so that the cage can be removed from the rack.

### CROSS REFERENCE TO RELATED APPLICATIONS

This application claims priority to U.S. Provisional Patent Application No. 61/112,045, filed Nov. 6, 2008, entitled “LOCKING ASSEMBLY,” the contents of which are hereby incorporated by reference in its entirety.

### FIELD OF THE INVENTION

The present invention relates generally to a mechanism for securing a laboratory cage onto a rack. More specifically, the invention relates to a lock having an opened position when removing the cage from the rack and a locked position when the cage is properly positioned within the rack. Preferably, the cage lock can swing into the locked position automatically via the force of gravity when released.

### BACKGROUND OF THE INVENTION

Laboratories often utilize racks having one or more cages therein that are moved within a laboratory room or to another area in an animal facility for processing, cleaning, etc. Therefore, it can be preferable to provide a locking mechanism to retain the cages within the rack and prevent the cages from sliding out of the rack or otherwise being inadvertently moved. Although the use of a locking mechanism can prevent inadvertent movement of the cage when it is positioned in the rack, the locking assembly is often difficult to operate and to incorporate into the rack design. Accordingly, an effective locking mechanism for retaining a cage in position in a rack that is easy to operate and incorporate into a rack is desired.

### SUMMARY OF THE INVENTION

A preferred embodiment of the present invention is directed to a locking assembly for securing and retaining a cage to a rack.

In accordance with an embodiment of the invention, the locking assembly is preferably supported on a rack having a canopy, wherein the cage is placed beneath the canopy. The locking assembly includes a pivoting member that is pivotable between an unlocked position and a locked position, wherein the pivoting member can be pivoted upward to an unlocked position and pivoted downward to a locked position. The pivotable member includes a protrusion that extends laterally across the front of the cage such that the protrusion prevents the cage from moving forward past the protrusion. Preferably, the pivoting member is urged to the locked position by the force of gravity. Therefore, the pivoting member can be pivoted upward to remove or insert a cage and once released, the pivoting member will drop back down by the force of gravity into the locked position.

In an exemplary embodiment, the pivotable member may have an undulating surface similar to the shape of a person's hand, such that by inserting the hand between the pivotable member and the cage, the technician or other person removing the cage can displace the pivotable member upward into the unlocked position. When the technician removes his hand from beneath the pivotable member, either after releasing the cage beneath the canopy or while removing the cage from the rack, the pivotable member will pivot downward to the locked position. Thus, no additional step is necessary to displace the pivotable member from the locked position to the unlocked position and vice versa.

Other objects and features of the present invention will become apparent from the following detailed description, considered in conjunction with the accompanying drawing figure.

It is to be understood, however, that the drawings are designed solely for the purpose of illustration and not as a definition of the limits of the invention, for which reference should be made to the appended claims.

### BRIEF DESCRIPTION OF THE DRAWINGS

The particular features and advantages of the invention as well as other objects will become apparent from the following description taken in connection with the accompanying drawings, in which:

FIG. 1 is a perspective view of a rack including a locking assembly in accordance with an embodiment of the invention;

FIG. 2 is a partial perspective view of a rack including a locking assembly in accordance with an embodiment of the invention;

FIG. 3 is a perspective view of a cage and canopy and locking assembly in accordance with an embodiment of the invention;

FIG. 4 is a front elevational view of the cage and canopy and locking assembly of FIG. 3;

FIG. 5 is a side elevational view of the cage and canopy and locking assembly of FIG. 3;

FIG. 6 is a perspective view of the cage and canopy and locking assembly of FIG. 3 in operation;

FIG. 7 is a perspective view of a locking member in accordance with an embodiment of the invention;

FIG. 8 is a bottom planar view of the locking assembly of FIG. 7.

### DESCRIPTION OF EXEMPLARY EMBODIMENTS

Certain exemplary embodiments of the present invention will now be described with reference to the drawings. In general, such embodiments relate to a locking assembly for retaining a cage in a rack, for example, while the rack is being moved. The locking assembly can be used with a ventilated rack having an air plenum providing air into or drawing air out of cages docked to the plenum, such as the rack system disclosed in U.S. patent application Ser. No. 11/871,942, filed Oct. 12, 2007, entitled “VENTILATED RACK SYSTEM,” the contents of which, are incorporated by reference herein.

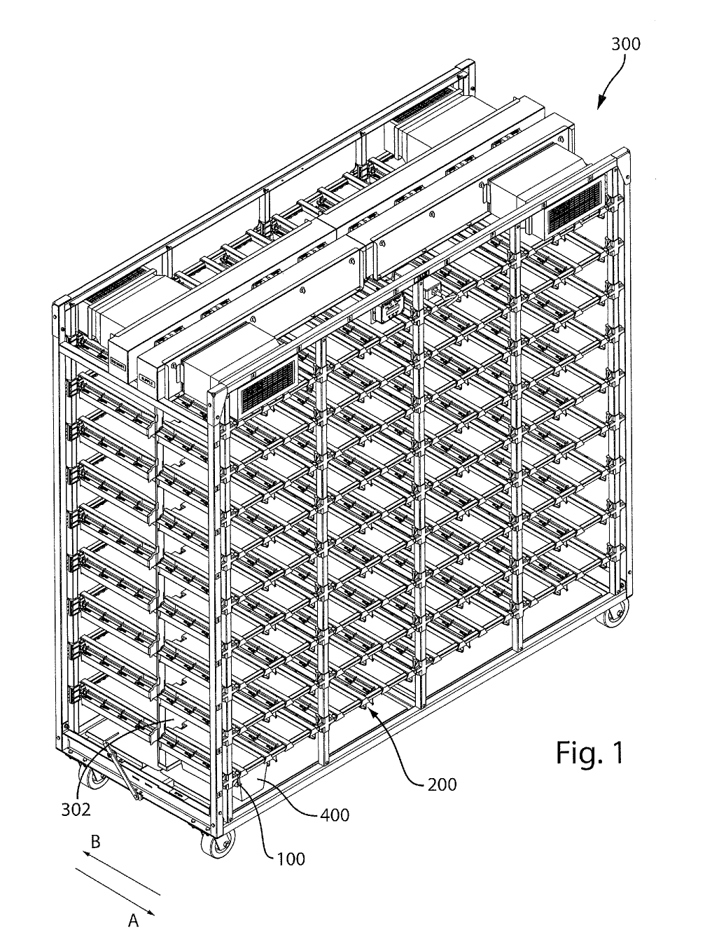

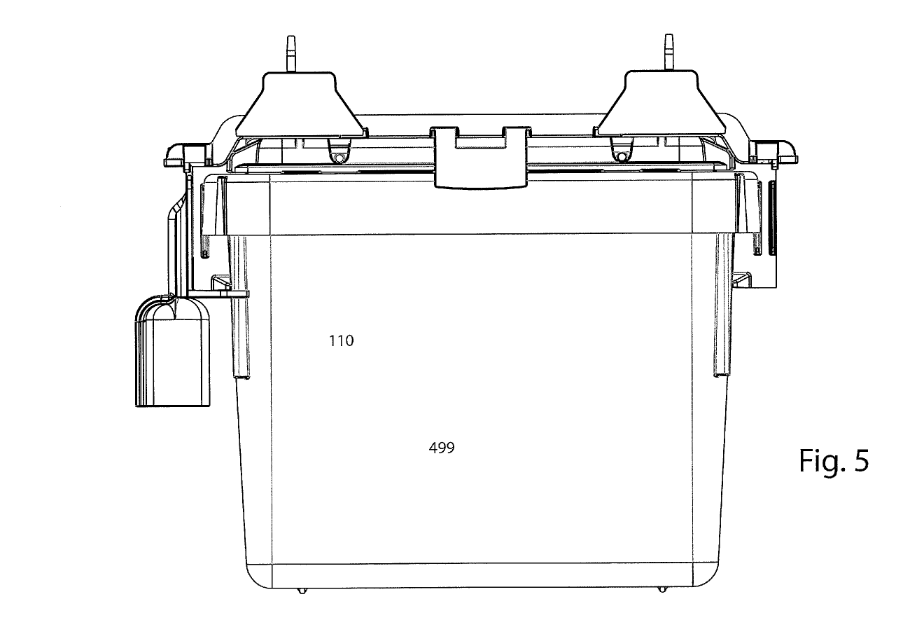

Referring to FIGS. 1-6, a rack generally indicated at 300, can include one or more canopies 200 for receiving a cage 400 beneath each canopy 200. In accordance with the embodiment shown, a locking assembly generally indicated as 10 includes a lock member 100, an obstruction member 110, and a support member, for example, the canopy 200, from which the lock member extends. It is to be understood that the support member can be the shelf, beam or other structure of the rack 300 without deviating from the scope of the invention. A lock member 100 is preferably connected to the canopy 200 and extends downward from the canopy 200 proximate the cage 400 such that the lock member 100 prevents the removal of the cage 400 from beneath the canopy 200 when the lock member 100 is in the locked position.

In accordance with an exemplary embodiment, cage 400 can be supported by canopy 200 and suspended above a canopy, shelf, base, etc. of the rack 300 beneath the cage 400. Alternatively, cage 400 can be supported on the canopy, shelf, base, etc. of the rack 300 beneath cage 400 in combination with or in lieu of being supported by the canopy 200 above the cage 400.

As shown in greater detail in FIGS. 1-4, the default position of the lock member 100, in the absence of external force, is preferably the locked position. Preferably, when lock member 100 is in the locked position, the body 108 of the lock member 100 extends downward from the canopy 200 and the obstruction member 110 of the locking assembly 10 extends in front of the cage 400. The obstruction member 110 thus prevents the displacement of the cage 400 toward the front of the rack 300 in direction A.

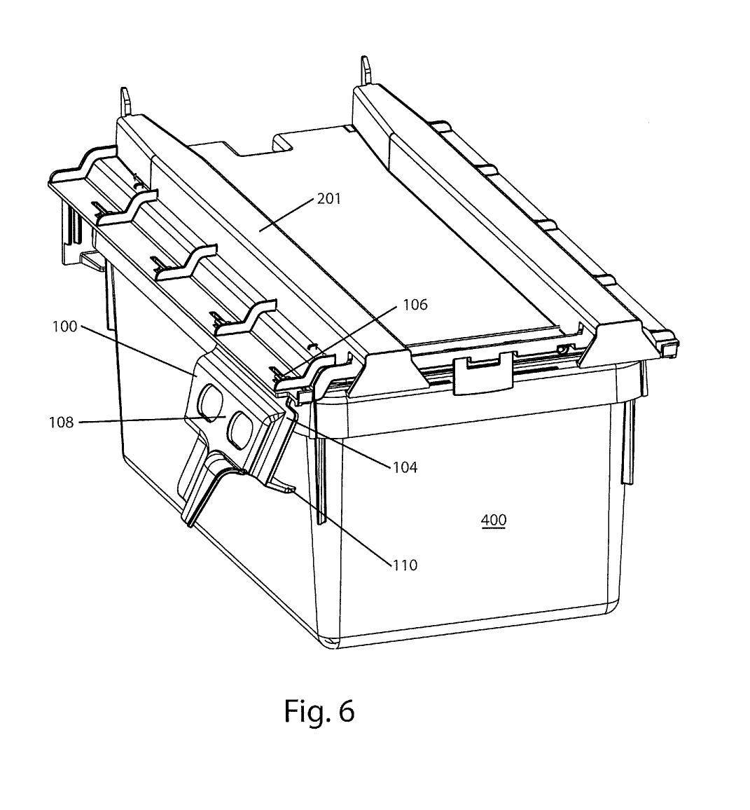

Referring to FIG. 6, the lock member 100 is constructed and arranged such that when a person, for example, a technician, wishes to remove the cage 400 from beneath the canopy 200 of the rack 300, the technician may insert a hand between the cage 400 and the lock member 100. Such a motion is preferably consistent with the technician's motion to grab the cage 400 on the side of the cage 400. Preferably, once the technician has inserted his hand a sufficient distance to properly grab the cage 400, the lock member 100 is displaced by the technician's hand without the need for any additional steps. Once the technician removes his hand from between the cage 400 and the lock member 100, the lock member 100 preferably returns to the default, locked position, more preferably by the force of gravity acting on the lock member 100.

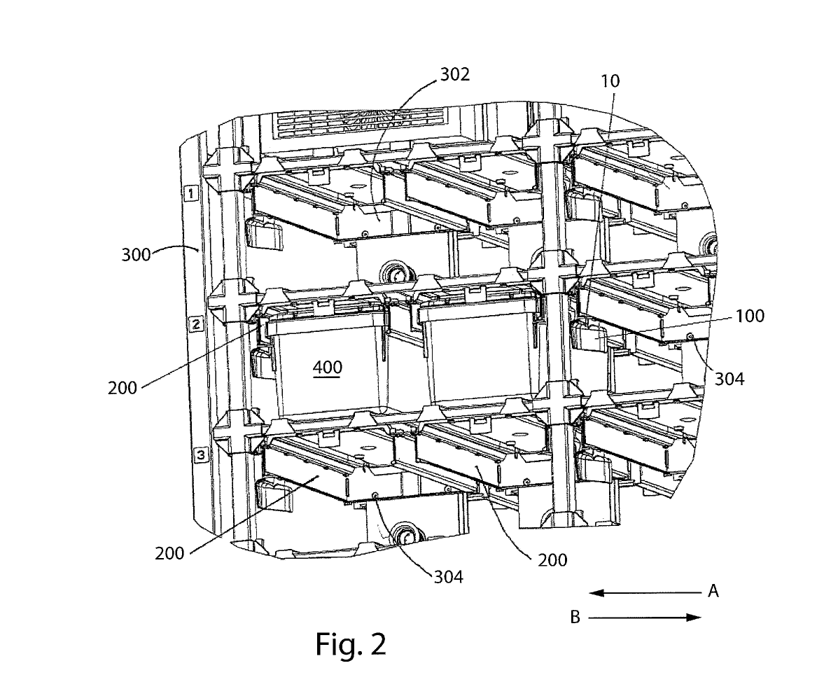

Referring to FIG. 2, a structure such as a beam, air plenum 302, etc. of the rack 300 can prevent the displacement of the cage 400 in direction B when the cage 400 is properly positioned in the rack 300. More preferably, the cage 400 can connect to an air valve 304 connected to the air plenum 302 of the rack 300 to provide air into and/or out of the cage 400. When the cage 400 is properly connected to the air plenum 302, for example, via a connecting grommet, the lock member 100 extending along the side of the cage 400, can be positioned such that the obstruction member 110 extends along the front of the cage 400 to prevent the displacement of the cage 400 in direction A past the obstruction member 110. Preferably, the distance between the obstruction member 110 and the air plenum 302 is such that the obstruction member 110 does not extend along the front of the cage 400 unless the cage is inserted a sufficient distance to ensure proper engagement with the air plenum 302.

Referring to FIGS. 1-6, the locking assembly 10 can include a lock member 100 and a support member from which the lock member 100 can hang downward. Whereas the support member is depicted as a canopy 200 of a rack 300 in which a cage 400 is housed, it is to be understood that the support member can vary as a matter of application specific design choice.

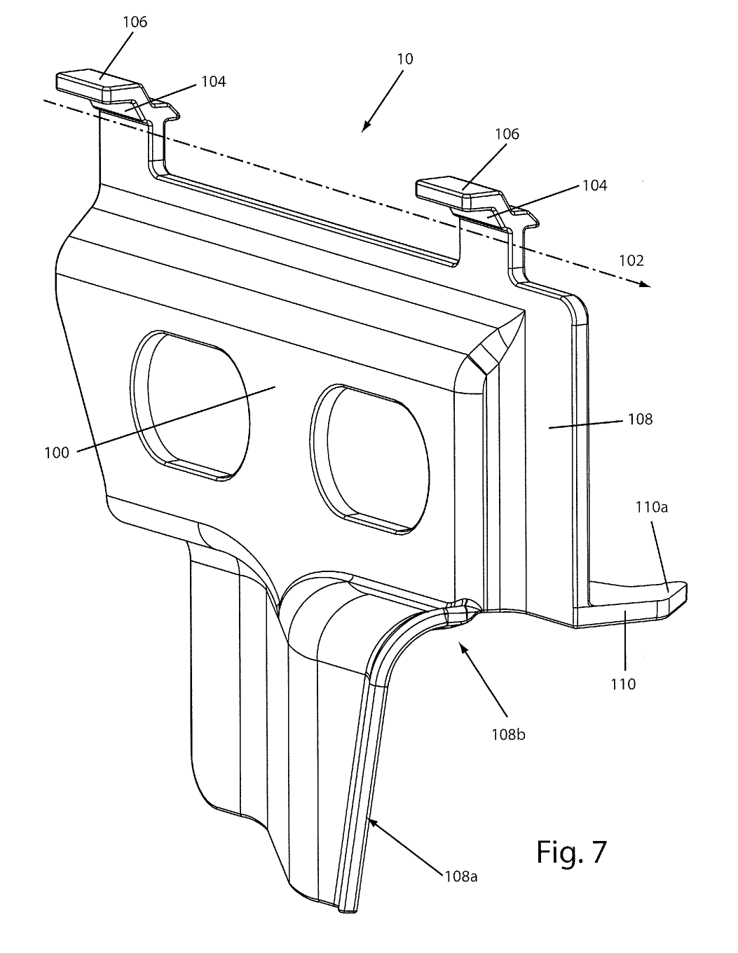

The lock member 100 preferably includes a body 108 extending downward from the canopy 200 adjacent to the respective cage 400. The lock member 100 is pivotable toward and away from the cage 400. Referring to FIG. 7, lock member 100 preferably has an axis 102 about which the lock member 100 can pivot, and one or more pivot projections 104 extending from the body 108 on the opposite side of axis 102 from the body 108.

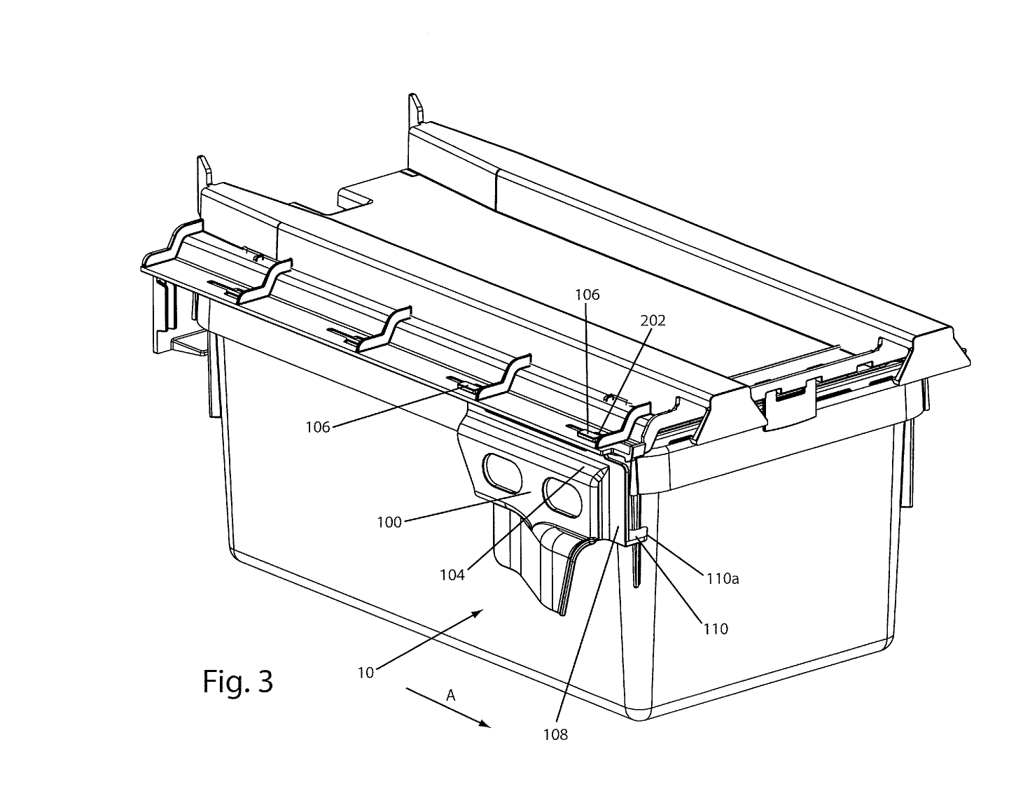

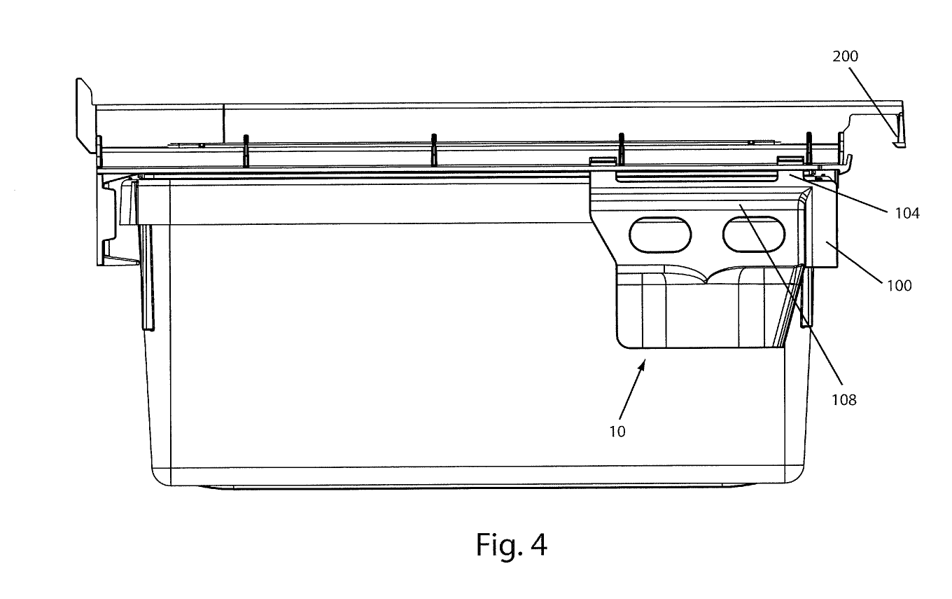

Referring to FIGS. 3-4, the lock member 100 preferably includes an obstruction member 110 for preventing the displacement of the cage 400 in a forward direction out of the rack 300. In the embodiment shown, obstruction member 110 extends perpendicularly from the body 108 toward the cage 400. Accordingly, when the lock member 100 is in a locked position, as shown in FIGS. 2-5, the body 108 extends downward next to the cage 400 and the obstruction member 110 extends from the body 108 in front of the cage 400. However, the position of the obstruction member 110 can vary, as long as the obstruction member 110 can obstruct the displacement of the cage 400 out of the rack 300.

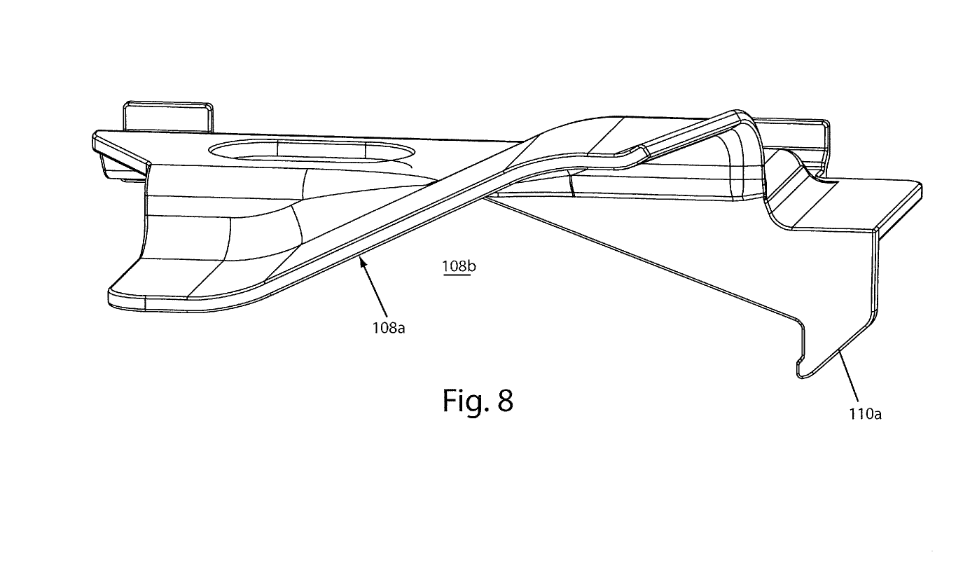

In accordance with an exemplary embodiment shown in FIGS. 6-8, the body 108 includes an undulating inner surface 108a having a size and shape similar to the outer contours of a person's hand. For example, the inner surface 108a is conformed generally to the shape of the top of a person's hand, the knuckles and the fingers. More specifically, the inner surface 108a can define a space 108b wherein the space 108b is wider proximate the front of lock member 100 and becomes narrower proximate the back of lock member 100, wherein the front of lock member 100 is proximate the opening of the rack 300 through which the cage 400 can be inserted and removed. As a person inserts his hand into the space 108b, the lock member 100 is urged away from the cage 400 to pivot upward. Accordingly, the mere insertion of a person's hand and grabbing the side of the cage 400 can be sufficient to displace the lock member 100 to an unlocked position, as illustrated in FIG. 6. When the lock member 100 is in the unlocked position, the obstruction member 110 is preferably clear of the path of the cage 400 so that the cage 400 can be inserted or removed from the rack 300.

In accordance with an exemplary embodiment, the canopy 200 can include one or more receiving apertures 202, grooves, etc. through which pivot projections 104 can be inserted or otherwise received by canopy 200 (FIG. 3). Pivot projections 104 may include a securing projection 106 for securing lock member 100 to the canopy 200. For example, securing projection 106 can extend laterally from the pivot projection 104 to prevent the inadvertent removal of pivot projections 104 through receiving apertures 202. Whereas the embodiment illustrated shows a securing projection 106 extending perpendicularly from pivot projection 104, it is to be understood that securing projection 106 can extend in more than one direction, and can have a variety of sizes and shapes. For example, securing projection 106 can have a spherical or cylindrical shape. Additionally, the lock member 100 can be connected to canopy 200 in a variety of ways without deviating from the scope of the invention. Alternatively, the support member includes a shelf, beam, etc. of the rack 300, or another structure preferably within the rack 300, without deviating from the scope of the invention.

In accordance with an embodiment of the support member as shown, the canopy 200 includes a support wall 206 for supporting the securing projection 106 thereon and for maintaining the securing projection 106 in place (FIG. 3).

The method of use of a locking assembly in accordance with an embodiment of the invention will be described herein. As shown in FIGS. 1-4, wherein cage 400 is received in rack 300 under canopy 200, the lock member 100 extends downward next to the cage 400 and obstruction member 110 extends from the lock member 100 in front of the cage 400. Accordingly, obstruction member 110 prevents cage 400 from being displaced in direction A and out of rack 400 (FIG. 2).

A technician can insert his hand into area 108b between the cage 400 and the body 108 of the lock member 100 to grab the cage 400. The technician preferably inserts his hand into area 108b until lock member 100 is urged upward by the hand, such that the body 108 pivots away from the cage 400 until obstruction member 110 is no longer in front of the cage 400, as shown in FIG. 6. Accordingly, the cage 400 can be removed from the rack in direction A. Preferably, no additional step of displacing the lock member 100 is necessary to clear the path of the cage 400 in direction A. Once the cage 400 is removed from the rack 300 past the obstruction member 110, the lock member 100 is released and permitted to pivot back downward to the locked position.

When the cage 400 is being inserted into the rack 300 under the canopy 200, the cage 400 can be displaced in direction B until it contacts the obstruction member 110 (FIG. 2). Preferably, the cage 400 pushes the obstruction member 110 in direction B, which results in the lock member 100 being urged upward and away from the cage 400. Referring to FIGS. 3 and 7, the obstruction member 110 can include a tapered portion 110a. Therefore, as the cage 400 is being inserted beneath the canopy 200, the cage 400 can contact the tapered portion 110a of the obstruction member 100. Because the tapered portion 110a permits the cage 400 to contact the obstruction member 110 at an acute angle due to the tapered portion 110a, the movement of the cage 400 in direction B can force the obstruction member 110 and thus the lock member 100 to pivot away from the cage 400 until the obstruction member 110 is clear of the path of the cage 400 and no longer obstructs the cage 400 from being displaced in direction B.

Once the cage 400 is released and the technician removes his hands from next to the cage 400, the lock member 100 will pivot downward. However, if the cage 400 is not inserted sufficiently into the rack 300, the lock member 100 can remain in the unlocked position. For example, the obstruction member 110 can contact the sidewall of the cage 400 if the cage 400 is not properly positioned in the rack 300. Once the cage 400 is inserted sufficiently in the rack 300, the obstruction member 110 preferably clears the cage and the lock member 100 can pivot downward to the lock position. In the lock position, the obstruction member 110 preferably extends in front of the cage 400, thus preventing the cage 400 from being inadvertently removed from the rack.

In accordance with an exemplary embodiment, the lock member 100 is formed of a molded plastic. However, other materials, such as metal, acrylic, etc. can be used as a matter of application specific design choice. Furthermore, the shape of the lock member 100 can be varied without deviating from the scope of the invention.

The examples provided are merely exemplary, as a matter of application specific to design choice, and should not be construed to limit the scope of the invention in any way. Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. For example, the mechanism for connecting the lock member to the canopy, the type of support member, the shape and arrangement of the obstruction member, etc. can be changed without deviating from the scope of the invention as a matter of application specific to design choice. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1. A locking assembly for retaining one or more cages supported in a rack assembly, the locking assembly comprising:
a lock member supported on the rack assembly, the lock member being moveable from a locked to an unlocked position; and
an obstruction member such that the obstruction member is moveable from an unobstructed to an obstructed position when the lock member is coordinately moved from an unlocked to a locked position so that the obstruction member extends in front of the cage to prevent the displacement of the cage from the rack.

2. The locking assembly of claim 1 wherein the lock member includes:
a body having an undulating inner surface constructed and arranged to accommodate the contours of a human hand; and
an axis about which the lock member can pivot upwards, away from the cage, into the unlocked position and downwards, toward the cage, into the locked position.

3. The locking assembly of claim 2 wherein the inner surface of the body defines a hand space that is wider proximate the front of the lock member and becomes narrower proximate the back of the lock member, wherein the insertion of a person's hand into the hand space is sufficient to cause the lock member to pivot upwards into the unlocked position.

4. The locking assembly of claim 2 wherein the lock member further includes one or more pivot projections extending from the body on the opposite side of axis from the body.

5. The locking assembly of claim 4 wherein:
each support member of the rack includes one or more apertures capable of receiving one of the pivot projections; and
each pivot projection includes a securing projection, the securing projection constructed and arranged to secure the lock member to the support member.

6. The locking assembly of claim 2 wherein the obstruction member includes a tapered portion to facilitate the insertion of cages into the rack system, the tapered portion constructed and arranged to allow the movement of the cage into the rack system to cause the obstruction member to pivot away from the cage.

7. A pivotable lock member, pivotable from a locked to an unlocked position and selectively connectable to a rack system with support members for retaining cages, the pivotable lock member comprising:
a body extending from one of the support members, adjacent to one of the cages when the pivotable lock member is in the locked position;
an axis about which the pivotable lock member can pivot upwards away from the cage into the unlocked position and downwards toward the cage into the locked position;
one or more pivot projections extending from the body on the opposite side of axis from the body; and

8. The pivotable lock member of claim 7 further comprising:
an obstruction member extending from the body, the obstruction member constructed and arranged to obstruct displacement of the cage out of the rack when the pivotable lock member is in the locked position.

9. The pivotable lock member of claim 8 wherein:
the obstruction member extends substantially perpendicularly from the body toward the cage.

10. The pivotable lock member of claim 8 wherein:
the obstruction member includes a tapered portion to facilitate the insertion of cages into the rack system, the tapered portion constructed and arranged to allow the movement of the cage into the rack system to cause the obstruction member to pivot away from the cage.

11. The pivotable lock member of claim 7 wherein:
the underneath inner surface of the body is wider proximate the front of the lock member and becomes narrower proximate the back of lock member so that insertion of a person's hand into the hand space is sufficient to cause the lock member to pivot upwards into the unlocked position.

12. The pivotable lock member of claim 7 wherein:
each support member of the rack system includes one or more apertures capable of receiving the one or more pivot projections; and
each pivot projection includes a securing projection, the securing projection constructed and arranged to secure the lock member to the support member.

13. The pivotable lock member of claim 12 wherein the securing projection extends away from the pivot projection to prevent the inadvertent removal of the pivot projection from the apertures of the support member.

14. The pivotable lock member of claim 12 wherein each support member of the rack system includes a sidewall for supporting the securing projection.

15. A pivotable lock member, pivotable from a locked to an unlocked position and selectively connectable to a rack system with support members for retaining cages, the pivotable lock member comprising:
a body extending from one of the support members, adjacent to one of the cages when the pivotable lock member is in the locked position;
an axis about which the pivotable lock member can pivot upwards away from the cage into the unlocked position and downwards toward the cage into the locked position; and

16. The pivotable lock member of claim 15 further comprising:
an obstruction member extending from the body, the obstruction member constructed and arranged to obstruct displacement of the cage out of the rack when the pivotable lock member is in the locked position.
